(19) United States
(12) Patent Application Publication
(10) Pub. No.: US 2025/0284985 A1
(43) Pub. Date: Sep. 11, 2025

(54) Pre-Generative Artificial Intelligence Prompt Comparison

(71) Applicant: Salesforce, Inc., San Francisco, CA (US)

(72) Inventors: Michael SHIRRELL, Noblesville, IN (US); Brian Cole, Hastings, MN (US)

(73) Assignee: Salesforce, Inc., San Francisco, CA (US)

(21) Appl. No.: 18/600,359

(22) Filed: Mar. 8, 2024

(51) Int. Cl. G06N 5/04; G06N 3/0475

(52) U.S. Cl. CPC G06N 5/04; G06N 3/0475

(57) ABSTRACT

Disclosed herein are system, method, and computer program product embodiments for using generative AI for prompt comparison. The system may receive a prompt. The prompt may include a request for information. The system may identify a stored prompt based on a similarity value between a received prompt for a large language model (LLM) and the stored prompt, the stored prompt including a response generated by the large language model (LLM). The system may generate a response using the LLM if the similarity value between the received and stored prompts is below a predefined threshold. The system may then modify the response by applying a first rule associated with a first designated phrase, and a second rule associated with a second designated phrase, where the first designated phrase comprises a banned phrase and where the second designated phrase comprises a selected phrase.

### BACKGROUND

One or more aspects relate to the field of using a large language model (LLM) to analyze prompts and generate responses.

LLMs are typically used in natural language processing (NLP) to perform a variety of tasks such as text summarization, translation, and speech recognition. LLMs may further be used for text generation. For example, an LLM may generate a response to a prompt or a question. One reason LLMs excel at NLP tasks is that they are trained on vast datasets including billions of tokens (e.g., words, word fragments).

### BRIEF DESCRIPTION OF THE DRAWINGS

The accompanying drawings are incorporated herein and form a part of the specification.

FIG. 1 illustrates an exemplary environment, according to embodiments of the present disclosure.

FIG. 2 illustrates a prompt engine, according to embodiments of the present disclosure.

FIG. 3 illustrates a decision tree diagram of an exemplary method for using pre-generative artificial intelligence prompt comparison, according to embodiments of the present disclosure.

FIG. 4 illustrates a flowchart diagram of an exemplary method for pre-generative artificial intelligence prompt comparison, according to embodiments of the present disclosure.

FIG. 5 illustrates a flowchart diagram of an exemplary method for identifying similar stored prompts, according to embodiments of the present disclosure.

FIG. 6 illustrates a flowchart diagram of an exemplary method for generating a new response, according to embodiments of the present disclosure.

FIG. 7 illustrates a block diagram of an exemplary computer system for implementing one or more aspects of the disclosed embodiments according to various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for pre-generative artificial intelligence prompt comparison.

LLMs are typically used in natural language processing (NLP) to perform a variety of tasks such as text summarization, translation, and speech recognition. LLMs may further be used for text generation. For example, an LLM may generate a response to a prompt or a question. One reason LLMs excel at NLP tasks is that they are trained on vast datasets including billions of tokens (e.g., words, word fragments). However, this means that the LLM may use or combine any of the training tokens when formulating a response. This may lead to inconsistent responses or responses with slight variations. In certain fields, such as finance or wealth management, precise language is required and there is a need to ensure that LLM responses are consistent. Thus, there is a need to leverage LLMs to generate responses while also tailoring them for certain environments or use cases.

Generative AI (e.g., LLMs) may be useful in communicating data between devices over a network. For example, a bank may host a chat bot that customers may use to request information about their account. The bank may leverage an LLM to interpret and respond to chat bot queries. As another example, a legal database may allow users to search for legal issues. Here, an LLM may interpret the query and generate a summary of the issue, using relevant statutes and case law. As stated above, LLMs may use any of its training data to formulate a response. This presents a problem in certain environments, where, an LLM is used but precise language is required. A prompt engine, as described below, may be used to receive prompts via a network, leverage an LLM to generate responses, and then filter responses based on one or more rules.

Certain systems may wish to filter or edit responses before they are sent to client devices over a network. For example, a system may wish to remove certain words or phrases from the response as well as add required language to the response. In some embodiments, systems may desire to use previous responses in order to save computing and network resources. For example, a received prompt may be compared to a set of stored prompts. If a certain degree of similarity between the received prompt and a stored prompt is detected, the system may output a response associated with the stored prompt.

For example, a first client device may be associated with a database administrator and the client device may send a prompt requesting the number of entries in the database. A system, described in more detail below, may receive the prompt, use an LLM to interpret it and generate a response. This prompt and response may then be stored. A second client device may send a second prompt asking for the same information. In this example, the system may first consult a store of saved prompts, and determine that the second prompt is the same as the first. In this example, the system may respond with the same response, previously generated by the LLM. This operation is beneficial to save computing resources as well as increase consistency of responses.

As will be discussed further, if none of the stored prompts match the received prompt or lack a required degree of similarity, the LLM may be leveraged to generate a new response to the prompt. LLM may be further leveraged if a predefined amount of time has passed between receiving the current prompt and when the stored prompt was received.

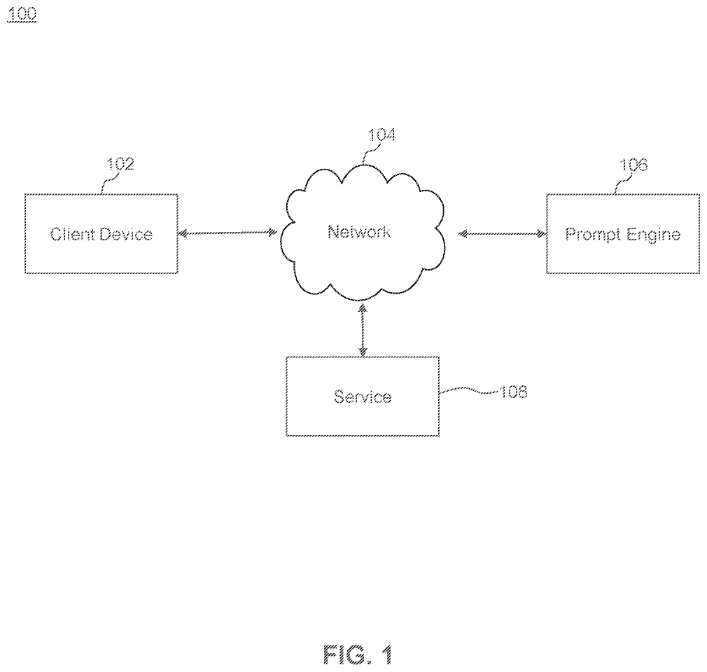

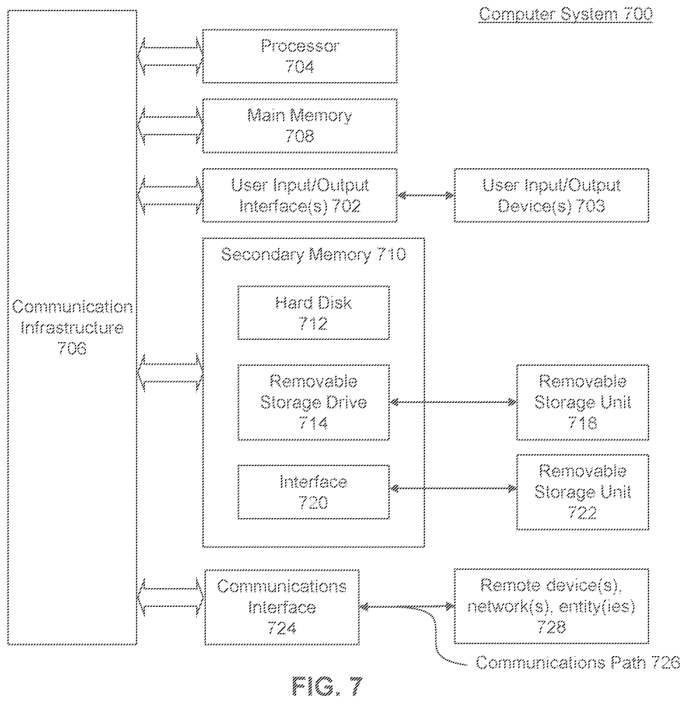

FIG. 1 illustrates an exemplary environment 100, according to embodiments of the present disclosure. Environment 100 may include client device 102, network 104, prompt engine 106, and service 108. Client device 102 may be any entity in communication with prompt engine 106. Client device 102 may be a computer system such as computer system 700 described with reference to FIG. 7. Client device 102 may be a client system such as a desktop workstation, laptop or notebook computer, netbook, tablet, smart phone, and/or other computing device that may be using an enterprise computing system. Client device 102 may be associated with service 108. For example, client device 102 may be affiliated with a customer or employee of service 108.

Network 104 may be any type of computer or telecommunications network capable of communicating data, for example, a local area network, a wide-area network (e.g., the Internet), or any combination thereof. The network may include wired and/or wireless segments. In some embodiments, network 104 may be a secure network.

Service 108 may be any resource that client device 102 attempts to access or request data from. For example, service 108 may be a financial institution (e.g., a bank) and client device 102 may belong to a customer of the financial institution. Although a single service 108 is depicted, environment 100 may include multiple services 108.

Prompt engine 106 may be implemented using one or more servers and/or databases. In some embodiments, prompt engine 106 may be implemented using a computing device such as a desktop workstation, laptop or notebook computer, netbook, tablet, smart phone, and/or other computing device. In some embodiments, prompt engine 106 may be implemented as an application in an enterprise computing system and/or a cloud-computing system. In some embodiments, prompt engine 106 may be a computer system such as computer system 700 described with reference to FIG. 7. Although a single prompt engine 106 is depicted, environment 100 may include multiple prompt engines 106. For example, each service 108 may be connected to a corresponding prompt engine 106. In some embodiments, a single prompt engine 106 may be used to respond to prompts associated with multiple services 108.

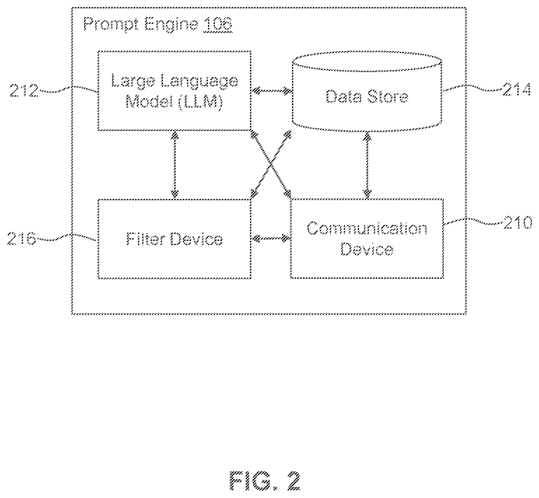

FIG. 2 illustrates prompt engine 106, according to embodiments of the present disclosure. Prompt engine 106 may include communication device 210, large language model (LLM) 212, data store 214, and filer device 216. Communication device 210 may be configured to communicate with client device 102 and service 108, via network 104. Communication device 210 may comprise any suitable network interface capable of transmitting and receiving data, such as, for example a modem, an Ethernet card, a communications port, or the like. Communication device 210 may be able to transmit data using any wireless transmission standard such as, for example, Wi-Fi, Bluetooth, cellular, or any other suitable wireless transmission.

Prompt engine 106 may be configured to receive prompts and generate responses to communications over network 104. In some embodiments, prompts may be received at prompt engine 106 from client device 102. When a prompt is received, prompt engine 106 may first query data store 214 to determine if data store 214 includes a stored prompt that is similar to the received prompt.

Data store 214 may be a memory device used to store data. Data store 214 may include various pieces of information such as previously received prompts and corresponding generated responses. Data store 214 may be categorized according to any method or schema. In some embodiments, data store 214 may be organized by service 108. Here, data store 214 may group prompts and their respective responses under the service 108 associated with the prompt. For example, a first service 108 may be associated with a bank, and a second service 108 may be associated with an online retailer. Since the prompts and responses to each of these services 108 may be different, it may be beneficial to keep the prompts and responses separate. This will help ensure that prompt engine 106 will return the most accurate response. As will be discussed further below, responses may be generated by LLM 212.

Prompt engine 106 may compare the received prompt to prompts stored at data store 214. Prompt engine 106 may use any means to make the comparison. In some embodiments, prompt engine 106 may convert the received prompt and the stored prompts to numerical vectors to perform the comparison. Once converted, prompt engine 106 may apply any vector similarity algorithm such as cosine similarity, Euclidean similarity, or dot product similarity. Prompt engine 106 may select the stored prompt with the highest similarity to the received prompt, and use the response corresponding to the stored prompt.

As stated above, prompt engine 106 may select a stored prompt with the highest similarity to the received prompt. In some embodiments, prompt engine 106 may set a similarity threshold. For example, prompt engine 106 may require that the stored prompt be at least 90% similar to the received prompt. If none of the stored prompts at data store 214 are above the threshold, prompt engine 106 may use LLM 212 to generate a new response.

LLM 212 may be a machine learning model represented by a set of weights. The weights may represent features that LLM 212 is designed to learn. LLM 212 may use any suitable machine learning architecture. For example, LLM 212 may be a transformer model. In some embodiments, prompt engine 106 may include a different LLM 212 for each service 108. In some embodiments, prompt engine 106 may include a single LLM 212 used for each service 108. In some embodiments, LLM 212 may be a single model, with different sets of weights for each service 108. LLM 212 may be trained to interpret prompts and generate responses based on the prompt. For example, the prompt may be a question and the response may be an answer. The prompt and response may include text, audio, video, or a combination thereof. For example, a prompt may be a written question such as, “How much money is in my bank account?” and LLM 212 may generate a response such as “There is $100 in your bank account.”

LLM 212 may be configured to customize the response based on client device 102. Data store 214 may include information on client device 102 and its associated user such as: name, address, occupation, education history, device information, device identifier, and previously received prompts and responses. Data store 214 may also include prompts previously received from client device 102. In some embodiments, data store 214 may further include client device's 102 interactions with service 108. LLM 212 may use this information to tailor the generated response.

For example, LLM 212 may be trained to include a greeting with the name of the user associate with client device 102 in each response. In this example, LLM 212 may access data store 214 to retrieve the name of the user associated with client device 102 to include within the response. As another example, client device 102 may send a prompt asking information regarding their bank account. LLM 212 may be configured to generate a template response such as “There is [BLANK] in your bank account.” Prompt engine 106 may retrieve information specific to client device's 102 bank account. If the information is at data store 214, prompt engine 106 may use the information from data store 214 to fill in the template. In some embodiments, the data may not be at data store 214. Here, prompt engine 106 may communicate with service 108 to obtain the information and fill in the template.

LLM 212 may use data at data store 214 for training. For example, LLM 212 may periodically train on data at data store 214 in order to increase its performance. Training data at data store 214 may be organized into examples. Each example may include a received prompt, the response sent to client device 102 (e.g., the actual response), and a label. The label may be a binary value such as 0 if the response was incorrect, and 1 if it was correct. The label may be a continuous value such as 10% correct, 50% correct, or 90% correct. In some embodiments, the label may be received from client device 102. In some embodiments, the label may be received from service 108.

LLM 212 may train by inputting the prompt and generating a response. The label and the actual response may be used to evaluate the generated response and update LLM 212. For example, if the label indicates the actual response successfully addressed the prompt, LLM may be optimized to generate a response similar to the actual response. If the label indicates the actual response failed to address the prompt, LLM 212 may be trained to generate a different response.

As will be discussed further below, responses may be edited to remove and include certain language. LLM 212 may therefore be trained to produce responses that require little to no alteration. This may be accomplished by applying a set of rules corresponding to banned and required words or phrases to the generated response. LLM 212 may be updated based on whether the generated response included banned words or phrases, and failed to include required words or phrases.

In some embodiments, information at data store 214 may be in its original format. For example, text-based prompts and responses may be stored as text, whereas image-based prompts and responses may be stored as images. In some embodiments, data store 214 may maintain the information as numerical vectors. Maintaining information at data store 214 as numerical vectors is beneficial to increase processing speed. As stated above, data store 214 may be searched to identify similar prompts and return the respective response. The search may be based on similarity between the received prompt and the stored prompts at data store 214.

Prior to outputting a response, prompt engine 106 may send the response to filter device 216. Filter device 216 may apply a set of rules to the response. Rules may include banned words, banned phrases, or a combination thereof, that may be removed from the response. The rules may also include selected or designated phrases that may be added to the response.

For example, filter device 216 may be configured to remove words from the response that are on a list of banned words. Filter device 216 may be further configured to remove phrases on a list of banned phrases. Filter device 216 may be further configured to add required words and/or phrases to a response. For example, a response to a prompt may require certain disclosure information. In this example, filter device 216 may be configured to add the disclosure information to the response. Prompt engine 106 may determine which rules are applied to the response.

For example, certain rules may be associated with certain services 108. Therefore, service 108 specific rules may be applied when the prompt and/or response involves the certain service 108. For example, client device 102 may be a banking customer and service 108 may be the bank. Client device 102 may submit a prompt requesting information regarding their bank account. Prompt engine 106 may generate a response. However, prior to outputting the response, prompt engine 106 may use filter device 216 to consult a set of rules defined by the bank (e.g., service 108). The bank may have defined a rule requiring certain disclosure materials be included in each response. Therefore, filter device 216 may add the disclosure provided in the rule, to the response. These rules may be unique to service 108. An additional request associated with a different service 108 may use a different set of rules. Allowing service 108 to define its own set of rules further ensures that responses from prompt engine 106 remain consistent. Additionally, prompt engine 106 may include rules that apply to all responses. For example, prompt engine 106 may include a rule preventing certain profanity from being included in responses.

Additionally, filter device 216 may apply rules that remove personally identifiable information (PII) from responses. PII may be a social security number (SSN), bank account number, passport number, driver's license number, credit card number, debit card number, date of birth, name, address, or phone number. Prompt engine 106 may configure filter device 216 to search for additional PII examples.

Each type of PII may have a rule determining whether it is removed from the response. For example, a name may be allowed to be part of a response (e.g., in a greeting) whereas an SSN is always removed. Similar to the rules previously discussed, each service 108 may define its own rules regarding PII. Filter device 216 may use one or more regular expressions to detect the PII and remove it from a response. In some embodiments, filter device 216 may leverage LLM 212 to detect PII. LLM 212 may be used to label each word and/or phrase of a response. The label may correspond to whether the word and/or phrase constitutes PII. Filter device 216 may remove portions of the response that are labeled PII.

In some embodiments, LLM 212 may train using the rules implemented by filter device 216. For example, data store 214 may include a training data set of rules currently enforced along with examples of each rule. Each example may include a response that is either in conformity with the rule or in violation of the rule. For example, a first rule may include a list of banned words. The first rule may have two accompanying examples. The first example may include one or more of the banned words along with a label. The second example may not include any banned words defined in the rule. LLM 212 may be trained to identify whether any of the banned words, defined in the first rule, are present in each example. Each example may have a corresponding label. The label may be defined with various degrees of precision. In some embodiments, the label may be a binary value denoting whether the example response violates the rule. In some embodiments, the label may include each word or phrase in violation of the rule, and it's location within the response. Training LLM 212 to learn rules implemented by filter device 119 will increase prompt engine's 106 performance and efficiency in analyzing and responding to prompts.

In some embodiments, prompt engine 106 may save the received prompt and the output of filter device 216 to data store 214. This may be beneficial so if a future prompt is similar to the received prompt, the same response may be used. Additionally, this information may be used to train LLM 212. The output of filter device 216 may be sent to client device 102 via network 104.

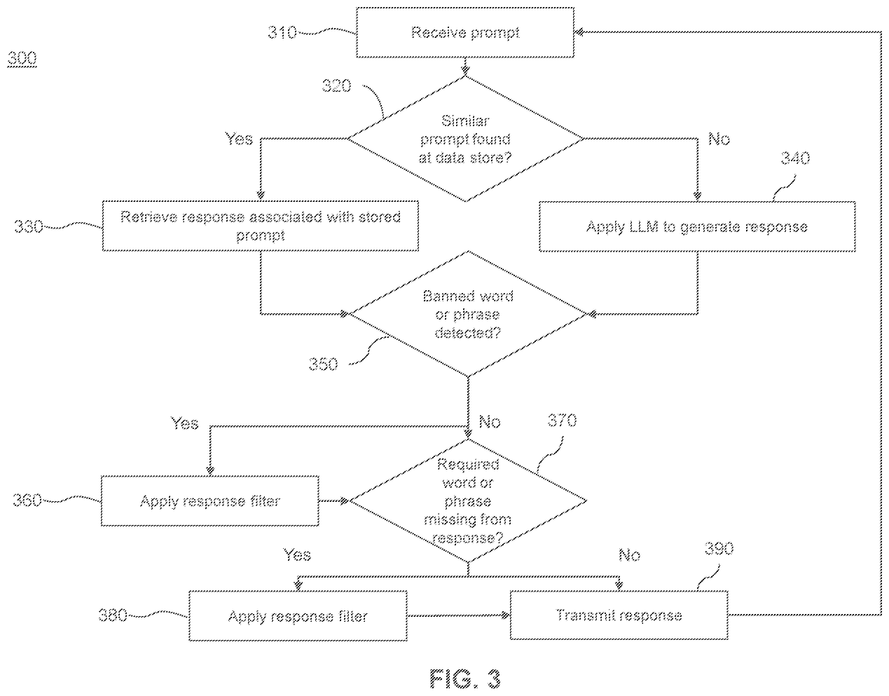

FIG. 3 illustrates a decision tree diagram of an exemplary method 300 for using pre-generative artificial intelligence prompt comparison, according to embodiments of the present disclosure. As shown in FIG. 3, method 300 begins at step 310 by prompt engine 106 receiving a prompt. The prompt may be received by client device 102 via network 104. The prompt may include text, audio, images, video, or any combination thereof. An example prompt may be, “How much money is in my bank account?”

At step 320, prompt engine 106 determines whether a similar prompt may be located at a data store. The data store may be data store 214. Prompt engine 106 may identify a similar prompt by computing the similarity between the received prompt and each stored prompt at data store 214. In some embodiments, prompt engine 106 may convert the received and stored prompts to numerical vectors. Prompt engine 106 may then calculate a vector similarity between the received prompt and stored prompt vectors. The vector similarity may be used as a similarity measure of the prompts. Prompt engine 106 may determine a threshold similarity value. For example, prompt engine 106 may require 80% similarity between the received and stored prompts. If a similar prompt is identified, method 300 continues to step 330, otherwise method 300 continues to step 340.

At step 330, prompt engine 106 retrieves the response associated with the stored prompt. The response may have been generated by LLM 212. In some embodiments, prompt engine 106 may edit the retrieved response. Prompt engine 106 may insert or replace words or phrases so that the response is tailored to the requesting entity (e.g., client device 102). For example, the response may include an identifier and prompt engine 106 may include an identifier corresponding to client device 102. Retrieving a response previously generated is beneficial because it results in consistency across responses.

At step 340, prompt engine 106 applies an LLM to the prompt to generate a response. The LLM may be LLM 212. As stated above, the LLM may be trained to perform natural language tasks such as language generation. Here, the LLM may input the prompt, analyze it, and output a response. In some embodiments, the LLM may output multiple responses according to a probability distribution. For example, each output may have a probability score corresponding to the LLM's confidence that the output is the correct one. Prompt engine 106 may use the response with the highest probability score.

At step 350, prompt engine 106 determines whether any banned words or phrases are in the response. Prompt engine 106 may use filter device 216 to perform the determination. Filter device 216 may consult a list of banned words or phrases. The list may be stored at filter device 216 or data store 214. Prompt engine 106 may define any list of banned words or phrases. The list of banned words and phrases may be organized into rules. For example, a first rule may include a first set of banned words and phrases, and a second rule may include a second set of banned words and phrases. As an example, a rule may ban profanity, and thus include a list of profane words and phrases to remove. A separate rule may be concerned with leaking PII. Therefore, the rule may include PII that should be removed from the response. In some embodiments, different rules may be defined by and associated with different services 108. If a banned word or phrase is detected, method 300 continues to step 360, otherwise method 300 continues to step 370.

At step 360, prompt engine 106 applies a response filter to remove the identified banned words and/or phrases. Prompt engine 106 may use filter device 216 to remove the banned words and/or phrases.

At step 370, prompt engine 106 determines whether a required word and/or a required phrase is missing from the response. Prompt engine 106 may consult a list of required words or phrases. The list may be stored at data store 214. The required words or phrase may also be organized as rules. In some embodiments, the rules may be associated with services 108. For example, certain services 108 may require certain words or phrases to be included within responses. Some rules may be associated with all responses, regardless of the service 108. For example, prompt engine 106 may define a rule that all responses should include a date/time field. If a required word or phrase is missing, method 300 continues to step 380, otherwise method 300 continues to step 390.

At step 380, prompt engine 106 applies a response filter to add the required words and/or phrases to the response. Prompt engine 106 may use filter device 216 to add the words and/or phrases.

At step 390, prompt engine 106 transmits the response. The response may be transmitted to client device 102 via network 104. In some embodiments, prompt engine 106 may further save the received prompt and generated response at data store 214. This may be useful to generate future responses as well as to train LLM 212.

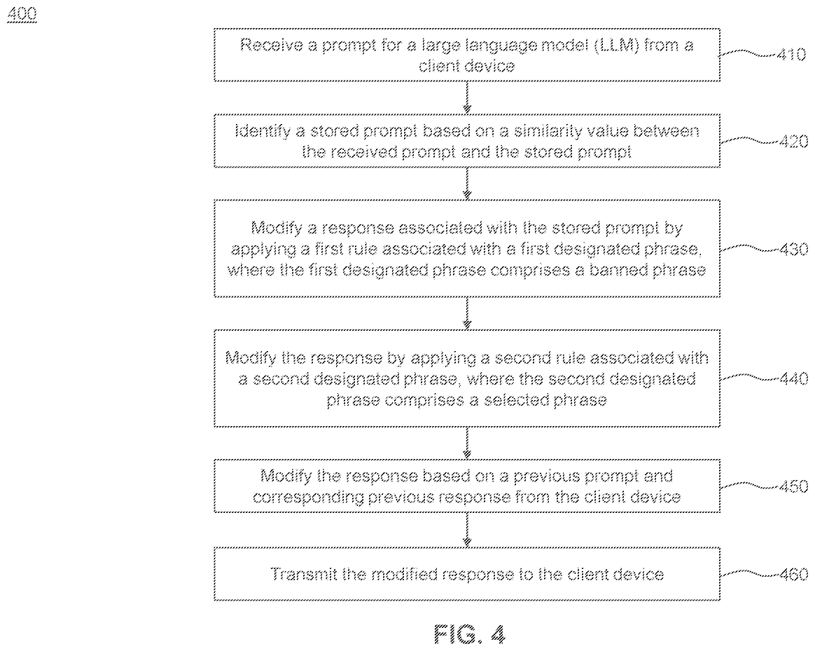

FIG. 4 illustrates a flowchart diagram of an exemplary method 400 for pre-generative artificial intelligence prompt comparison, according to embodiments of the present disclosure. Method 400 may be used to receive a prompt and leverage an LLM to respond to the prompt. As shown in FIG. 4, method 400 begins at step 410 by prompt engine 106 receiving a prompt for a large language model (LLM) from a client device. The LLM may be LLM 212. The client device may be client device 102.

At step 420, prompt engine 106 identifies a stored prompt based on a similarity value between the received prompt and the stored prompt. The stored prompt may have an associated stored response generated by the LLM. The similarity value may be determined by converting the received prompt and stored prompt into vector representations and then calculating the vector similarity.

At step 430, prompt engine 106 modifies the response by applying a first rule associated with a first designated phrase, where the first designated phrase comprises a banned phrase. In some embodiments, the banned phrase may be a single word or a collection of words (e.g., a phrase). In some embodiments, prompt engine 106 may use filter device 216 to modify the response. For example, filter device 216 may remove any banned words and/or phrases detected in the response.

At step 440, prompt engine 106 modifies the response by applying a second rule associated with a second designated phrase, where the second designated phrase comprises a selected phrase. The selected phrase may also be a single word or a collection of words (e.g., a phrase). The selected phrase may be required to be part of the response. In some embodiments, prompt engine 106 may use filter device 216 to modify the response. For example, filter device 216 may add any required words and/or phrases to the response.

At step 450, prompt engine 106 modifies the response based on a previous prompt and previous response from the client device. The client device may be client device 102. The previous prompt may be located at data store 214. The previous response may be associated with the previous prompt at data store 214. Prompt engine 106 may identify the previous prompt by searching data store 214 based on an identifier associated with client device 102. Prompt engine 106 may modify the response by including information related to client device 102 and/or a user associated with client device 102.

For example, the prompt received at step 410 may only include a numeric identifier associated with client device 102. However, the previous response may include a name of a user associated with client device 102. Here, prompt engine 106 may modify the response by inserting the name of the user associated with client device 102.

In some embodiments, prompt engine 106 may not modify the response if a predefined amount of time has passed between the received prompt and previous prompt. For example, if a year has passed between the received prompt and the previous prompt, prompt engine 106 may not reference the previous prompt since data associated with it may have changed.

In some embodiments, prompt engine 106 may not modify the response if it detects the modification no longer applies. For example, client device 102 may have belonged to a first employee when the previous prompt was received. Subsequently, client device 102 may have been transferred to a second employee who may have sent the current prompt. Prompt engine 106 may detect that the user associated with client device 102 has changed, and thus may not reference the previous prompt to modify the current prompt.

At step 460, prompt engine 106 transmits the modified response to the client device. As stated above, the client device may be client device 102. Prompt engine 106 may use communication device 210 to transmit the response via network 104. In some embodiments, prompt engine 106 may additionally save the prompt and modified response to data store 214. This is beneficial so that the prompt and modified response may be referenced in in responding to future prompts.

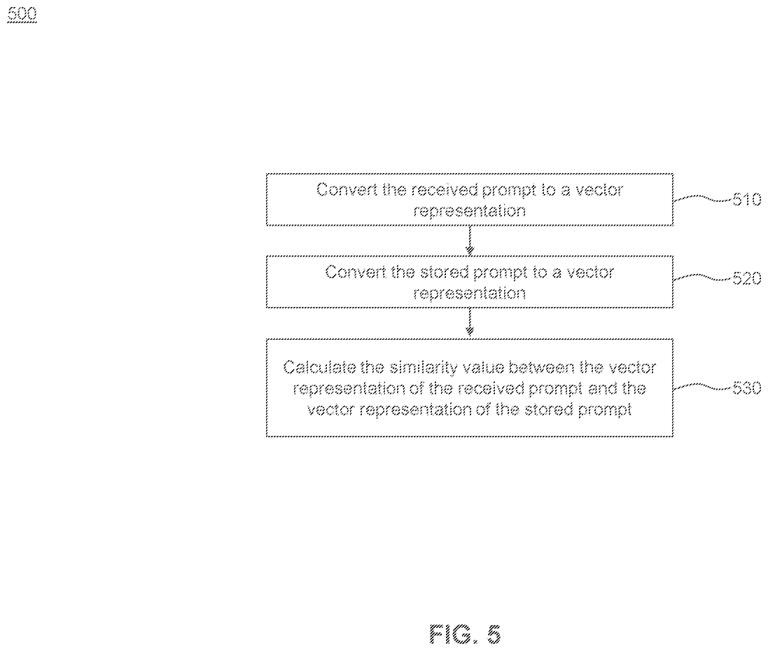

FIG. 5 illustrates a flowchart diagram of an exemplary method 500 for identifying similar stored prompts, according to embodiments of the present disclosure. Method 500 may be used by prompt engine 106 to identify previously received, stored prompts. The responses associated with the previously received prompt may then be used to respond to the current prompt. This process is beneficial to ensure that responses to similar or related prompts are consistent. Method 500 may include additional details related to 420 as described with reference to method 400.

As shown in FIG. 5, method 500 begins at step 510 by prompt engine 106 converting the received prompt to a vector representation. In the vector representation, each word or part of a word may be represented by a number. In some embodiments, prompt engine 106 may use a lookup table to convert each word to a number. In some embodiments, prompt engine 106 may use a tokenization algorithm to generate the vector representation. The result of the tokenization algorithm may be that similar words have similar vector representations. This may be beneficial so that the meaning of the words is captured via their vector representations. For example, words that are synonyms (e.g., ocean and lake) should have closer vector representations than words that are unrelated (e.g., ocean and computer).

At step 520, prompt engine 106 converts the stored prompt to a vector representation. Prompt engine 106 may use the same technique used in 510 above.

At step 530, prompt engine 106 calculates the similarity value between the vector representation of the received prompt and the vector representation of the stored prompt. The similarity value may be determined by any vector similarity algorithm. Prompt engine 106 may calculate the similarity value using cosine similarity, Euclidean similarity, or dot product similarity.

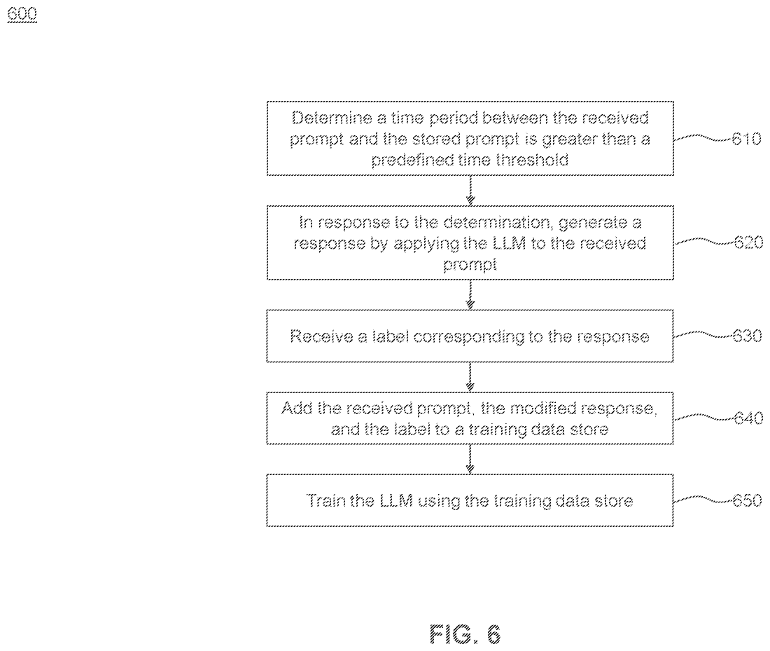

FIG. 6 illustrates a flowchart diagram of an exemplary method 600 for generating a new response, according to embodiments, according to embodiments of the present disclosure. Prompt engine 106 may use method 600 in order to update stored responses and subsequently retrain an LLM using the updated stored responses. As stated above, data communicated in environment 100 may rapidly change. Changes may apply to the data itself, its format, included fields, as well as elements that are required to be communicated and elements that are barred from being communicated. For example, service 108 may be a financial institution. In the financial industry, required disclosures may change resulting from new laws or regulations. Therefore, it's desirable to generate new responses after a certain amount of time has passed in order to capture these updates. In this example, method 600 may be used to detect a predefined amount of time has passed between receiving the current prompt and when the stored prompt was received, and therefore that a new response should be generated.

During the time window between when the stored response was created and the latest prompt received, LLM 212 may have been updated according to any new laws, rules, and/or regulations. Therefore, creating a new response would also conform to those updates. For example, if the identified stored prompt was received six months prior to the current prompt, prompt engine 106 may be configured to leverage LLM 212 to create a new response. Method 600 may include additional details related to 420 as described with reference to method 400.

As shown in FIG. 6, method 600 begins at step 610 by prompt engine 106 determining that a time period between the received prompt and the stored prompt is greater than a predefined time threshold. The time period may be determined by calculating the difference between timestamps of the received prompt and stored prompt. The predefined time threshold may be any time value such as one week, one month, or one year. In some embodiments, service 108 associated with the prompt may define the predefined time threshold and communicate it to prompt engine 106 via network 104.

At step 620, prompt engine 106, in response to the determination, generates a new response by applying the LLM to the received prompt. The LLM may be LLM 212. As stated above, the LLM may be trained to perform natural language tasks such as language generation. Here, the LLM may input the prompt, analyze it, and output a response. In some embodiments, the LLM may output multiple responses according to a probability distribution. For example, each output may have a corresponding probability score corresponding to the LLM's confidence that the output is the correct one. Prompt engine 106 may select the response with the highest probability score.

As described above with regard to steps 430, 440, and 450, prompt engine 106 may then use filter device 216 to modify the response. For example, filter device 216 may use a set of rules to remove banned words and/or phrases, and add required words and/or phrases. Filter device 216 may further modify the response based on information associated with the client device (e.g., client device 102).

At step 630, prompt engine 106 receives a label corresponding to the response. The label may indicate how effective the response was at addressing the prompt. The label may be received from client device 102 or service 108. The label may be a binary, discrete, or continuous value. In some embodiments, the label may include a ground truth response. For example, LLM 212 may have generated an incorrect response to the prompt. In response, client device 102 or service 108 may send prompt engine 106 a ground truth response (e.g., a correct response) so that LLM 212 may be retrained. As an illustration, a prompt such as “What is the capital of the United States?” may be received. LLM 212 may generate an incorrect response, “Baltimore.” Client device 102 and/or service 108 may respond with a label including “Washington, D.C.” Providing the ground truth or correct response to a given prompt will allow LLM 212 to be retrained and provide more accurate responses in the future.

At step 640, prompt engine 106 adds the received prompt, the modified response, and the label to a training data store. In some embodiments, the training data store may be part of data store 214. In some embodiments, entries at the training data store may be overwritten. For example, the training data store may be configured to hold a certain amount of information. In some embodiments, the training data store may be configured to hold a certain number of examples. Each example may include a received prompt, the modified response, and the label. In some embodiments, prompt engine 106 may configure the training data store to hold data over a certain time window. For example, prompt engine 106 may configure the training data store to include examples from the last month, six months, or year. This may be beneficial because data in environment 100 may rapidly change, and it may be critical that LLM 212 trains on the latest information.

The modified response may be the response created by LLM 212, modified by filter device 216, and ultimately sent to client device 102. As stated above, filter device 216 may have removed banned words and/or phrases as well as added required words and/or phrases to the response generated by LLM 212.

At step 650, prompt engine 106 trains the LLM using the training data store. In some embodiments, the LLM may be LLM 212. Training LLM 212 may be useful to improve its performance with regard to generating accurate and precise responses to received prompts. Training may involve LLM 212 iterating over each stored prompt at the training data store, and generating a response.

LLM 212 may use the generated response to update its weights. The update may depend on the label corresponding to the example. For example, if a label indicates that the response was accurate with regard to the prompt, then ideally, the response generated by LLM 212 should be similar to or match the actual response sent to client device. Here, an error may be based on the difference between the generated response and the actual response. The error may be calculated by converting each response into a vector, and then calculating a similarity between the vectors. In this instance, the more similar the vectors, the smaller the error may be. The error may be used to update LLM 212 so that its generated response is more similar to the actual response. For example, backpropagation may be used to update LLM 212.

Conversely, a label may indicate that the response sent to the client device was incorrect, or did not effectively respond to the prompt. In this example, LLM 212 should generate a response that is dissimilar to the actual response. Similar to the process above, an error may be calculated based on the similarity to the generated response and the actual response. In this case, the similarity should be low (e.g., the responses should be dissimilar) because the actual response did not address the prompt. Therefore, LLM 212 should be trained to respond differently to the prompt. The calculated error may be used to update LLM 212.

It will be understood that the order of the above steps are merely exemplary, and the steps can be rearranged in any appropriate manner. Additionally, more or fewer steps may be included in the exemplary method consistent with the disclosure.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include customer input/output device(s) 703, such as monitors, keyboards, pointing devices, etc., which may communicate with communication infrastructure 706 through customer input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random-access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings included in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
a memory; and
at least one processor coupled to the memory and configured to:
identify a stored prompt based on a similarity value between a received prompt for a large language model (LLM) and the stored prompt, the stored prompt including a response generated by the large language model (LLM); and
modify the response by applying a first rule associated with a first designated phrase, and a second rule associated with a second designated phrase,
wherein the first designated phrase includes a banned phrase, and
wherein the second designated phrase includes a selected phrase.

2. The system of claim 1, wherein the identifying further comprises:
converting the received prompt to a vector representation;
converting the stored prompt to a vector representation; and
calculating the similarity value between the vector representation of the received prompt and the vector representation of the stored prompt.

3. The system of claim 2, wherein the similarity value is calculated via one of a cosine similarity, Euclidean similarity, or dot product similarity.

4. The system of claim 1, wherein identifying further comprises:
determine a time period between the received prompt and the stored prompt is greater than a predefined time threshold; and
in response to the determination, generating the response by applying the LLM to the received prompt.

5. The system of claim 1, wherein the banned phrase is removed from the response.

6. The system of claim 1, wherein the selected phrase is added to the response.

7. The system of claim 1, wherein the prompt is received from a client device, and the modification further comprises:
identifying a previous prompt received from the client device;
modifying the response based on the previous prompt from the client device.

8. A method, comprising:
identifying a stored prompt based on a similarity value between a received prompt for a large language model (LLM) and the stored prompt, the stored prompt including a response generated by the large language model (LLM); and
modifying the response by applying a first rule associated with a first designated phrase, and a second rule associated with a second designated phrase,
wherein the first designated phrase comprises a banned phrase, and
wherein the second designated phrase includes a selected phrase.

9. The method of claim 8, further comprising:
converting the received prompt to a vector representation;
converting the stored prompt to a vector representation; and
calculating the similarity value between the vector representation of the received prompt and the vector representation of the stored prompt.

10. The method of claim 9, wherein the similarity value is calculated via one of a cosine similarity, Euclidean similarity, or dot product similarity.

11. The method of claim 8, wherein the identifying further comprises:
determining a time period between the received prompt and the stored prompt is greater than a predefined time threshold; and
in response to the determination, generating the response by applying the LLM to the received prompt.

12. The method of claim 8, wherein the banned phrase is removed from the response.

13. The method of claim 8, wherein the selected phrase is added to the response.

14. The method of claim 8, wherein the prompt is received from a client device, and the modifying further comprises:
identifying a previous prompt received from the client device;
modifying the response based on the previous prompt from the client device.

15. A non-transitory computer-readable device having instructions stored thereon that, when executed by at least one computing device, cause the at least one computing device to perform operations comprising:
identifying a stored prompt based on a similarity value between a received prompt for a large language model (LLM) and the stored prompt, the stored prompt including a response generated by the large language model (LLM); and
modifying the response by applying a first rule associated with a first designated phrase, and a second rule associated with a second designated phrase,
wherein the first designated phrase comprises a banned phrase, and
wherein the second designated phrase includes a selected phrase.

16. The non-transitory computer-readable device of claim 15, wherein the operations further comprise:
converting the received prompt to a vector representation;
converting the stored prompt to a vector representation; and
calculating the similarity value between the vector representation of the received prompt and the vector representation of the stored prompt.

17. The non-transitory computer-readable device of claim 16, wherein the similarity value is calculated via one of a cosine similarity, Euclidean similarity, or dot product similarity.

18. The non-transitory computer-readable device of claim 15, wherein the identifying further comprises:
determining a time period between the received prompt and the stored prompt is greater than a predefined time threshold; and
in response to the determination, generating the response by applying the LLM to the received prompt.

19. The non-transitory computer-readable device of claim 15, wherein the banned phrase is removed from the response.

20. The non-transitory computer-readable device of claim 15, wherein the selected phrase is added to the response.
